(19) United States
(12) Patent Application Publication
(10) Pub. No.: US 2013/0336213 A1
(43) Pub. Date: Dec. 19, 2013

(54) GATEWAY DEVICE AND PACKET COMMUNICATION METHOD

(71) Applicant: HITACHI, LTD., Tokyo (JP)

(72) Inventors: Nodoka MIMURA, Tokyo (JP); Masashi YANO, Kawasaki-shi (JP); Masahiro TAKATORI, Yokohama-shi (JP); Naruhito NAKAHARA, Yokohama-shi (JP)

(21) Appl. No.: 13/920,385

(22) Filed: Jun. 18, 2013

(30) Foreign Application Priority Data
Jun. 19, 2012 (JP) 2012-137381

(51) Int. Cl. H04W 40/00

(52) U.S. Cl. CPC H04W 40/00
USPC 370/328

(57) ABSTRACT

In packet communication using TCP, a gateway device for relaying communication packets between a mobile node and a correspondent node, temporarily rewrites a parameter of the receive window size of the ACK packet of the TCP communication from the mobile node, to adjust the amount of communication packets transmitted from the correspondent node. Whit this configuration, it is possible to reduce the packet loss due to error control for the existing TCP communication with respect to the mobile node, without converting the mobile node and the correspondent node.

### CLAIM OF PRIORITY

The present application claims priority from Japanese patent application JP2012-137381 filed on Jun. 19, 2012, the content of which is hereby incorporated by reference into this application.

### BACKGROUND OF THE INVENTION

The present invention relates to a gateway device and a communication method, and more particularly, to a packet communication technology for reducing packet loss when a mobile node switches the network connection to a different wireless network system.

Because of the rapid increase of the number of users of smart phones and tablet devices as well as the expansion of video content, the communication traffic in the mobile communication network has explosively increased. It is expected to be difficult to catch up with the rapid increase in the communication traffic only by stand-alone wireless network systems such as 3rd Generation (3G) or Long Term Evolution (LTE).

Under such circumstances, standard bodies such as the 3rd Generation Partnership Project (3GPP) and the Internet Engineering Task Force (IETF) have discussed the development of a packet communication system to accommodate the mobile communication traffic, by an integrated approach of using other wireless network systems such as wireless LAN (WLAN: Wireless Local Access Network) and mobile WiMAX (Worldwide Interoperability for Microwave Access), in addition to 3G and LTE. In the packet communication system, the mobile node can connect to a plurality of wireless network systems and can switch the network connection according to the situation. In this way, it is possible to transfer the communication traffic not only a single wireless network system but also other wireless network systems. This technology is called traffic offload.

In such packet communication systems, it is preferable that the mobile node switches the connection between wireless network systems seamlessly. There are two requirements for the seamless switching. One requirement is that when the mobile node switches the wireless network system to be connected, it is possible to continue the communication without disconnecting any of the existing packet communication sessions. In order to achieve this, the mechanism has been standardized as the architecture. Another requirement is to minimize the error control in the Transport Control Protocol (TCP), which is the protocol typically used for the packet communication. This has not been discussed by the standards bodies.

In TCP, the throughput and the round trip time of the communication with the correspondent node that is the communication target are calculated or estimated and used as parameters for control. When the mobile node switches the wireless network system to be connected, the values of the bandwidth and the delay time vary greatly. However, the TCP may not quickly follow such variations, so that packet loss and packet retransmission occur due to error control. As a result, there is a problem that the throughput is reduced. For example, when the mobile node switches from WLAN to 3G, the bandwidth is reduced and the delay time is increased. The TCP control of the correspondent node assumes that the mobile node is still connected to WLAN and thus transmits too many packets to be processed by 3G. As a result, before the packets arrive at the mobile node, significant packet loss occurs in the 3G network. On the other hand, when the mobile node switches from 3G to WLAN, the bandwidth is increased and the delay time is reduced. The TCP control of the correspondent node is affected by the parameters in the 3G connection and thus transmits too small amount of packets for WLAN. As a result, there is a problem that the original bandwidth of the WLAN system is not completely used.

To solve this problem, Japanese Patent Application Laid-Open No. 2009-188666 discloses a technology for reducing the amount of data transfer during heterogeneous network handover processing in the mobile network. When heterogeneous network handover, namely, switching of the wireless network system to be connected is expected to be performed or has been performed, the mobile node sets the receive window size, which is one of the control parameters of TCP, based on the ability of the wireless interface. Further, Japanese Patent Application Laid-Open No. 2010-213013 discloses a technology for selecting the optimal TCP parameters in communication through a cognitive base station. Upon switching the wireless network system to be connected, the mobile node calculates the optimal TCP control parameter for the switched wireless interface, and transmits the control signal to the transmission server which is the correspondent node. Then, the transmission server determines the amount of TCP packets to be transmitted, by using the calculated control parameter.

### BRIEF SUMMARY OF THE INVENTION

In the method described in JP-A No. 2009-188666, it is necessary to convert the mobile node to the TCP stack. Thus, this method may not be applied to all mobile nodes. In addition, the mobile node does not find the appropriate receive window size unless it actually performs communication for a while. For this reason, it is difficult to properly control TCP immediately after the mobile node switches the wireless network system to be connected. Another method can be considered in which the mobile node measures the window size of each wireless network system in advance. However, the load on the wireless network system is too large when all the mobile nodes perform the measurement. Further, the method described in JP-A No. 2010-213013 requires cooperation between the transmission server and the cognitive base station, so that it is necessary to convert the transmission server to the TCP stack. Thus, also this method may not be applied to all transmission servers.

Accordingly, it is desirable to reduce the packet loss due to error control for the existing communication such as TCP with respect to a mobile node, when the mobile node switches the network connection to a different wireless network system, without converting the mobile node and the correspondent node.

An object of the present invention is to solve the above problem, and provide a gateway device and a packet communication method that can reduce the packet loss due to error control when a mobile node switches the network connection to a different communication system.

In order to achieve the above object, according to the present invention, there is provided a gateway device including a processing unit for mediating the exchange of communication packets between a mobile node capable of wireless communication by connecting to a first wireless network system or a second wireless network system and a correspondent node capable of communication through the IP service network. When the mobile node, which is communicating with the correspondent node by connecting to the first wireless network system, switches the connection to the second wireless network system, the processing unit rewrites a received parameter in an ACK packet of the communication transmitted from the mobile node after switching from the first wireless network system to the second wireless network system. Then, the processing unit transfers the rewritten parameter to the correspondent node, in order to control the amount of communication packets to be transmitted from the correspondent node.

Further, in order to achieve the above object, according to the present invention, there is provided a packet communication method of a gate way device. The packet communication method mediates the exchange of communication packets between a mobile node capable of wireless communication by connecting a first wireless network system or a second wireless network system and a correspondent node capable of communicating through the IP service network. When the mobile node, which is communicating with the correspondent node by connecting to the first wireless network system, switches the connection to the second wireless network system, the packet communication method rewrites a received parameter in an ACK packet of the communication transmitted from the mobile node after switching from the first wireless network system to the second wireless network system. Then, the packet communication method transfers the rewritten parameter to the correspondent node, in order to control the amount of communication packets to be transmitted from the correspondent node.

According to the present invention, it is possible to reduce the packet loss due to error control for the existing communication with respect to a mobile node and to stabilize the communication, when the mobile node switches the network connection to a different wireless network system, without converting the mobile node and the correspondent node.

### BRIEF DESCRIPTION OF THE DRAWINGS

FIG. 1 is a block diagram showing a configuration of a packet communication system according to a first embodiment;

FIG. 2A is a block diagram showing a general configuration of a service-network gateway according to the first embodiment;

FIG. 2B is a block diagram showing an example of the hardware configuration of a gateway device according to the first embodiment;

FIG. 3 is a view of an example of the software program of the service-network gateway according to the first embodiment;

FIG. 4 is a view of an example of the sequence for updating the statistical information table held by the service-network gateway according to the first embodiment;

FIG. 5 is a view of an example of the data structure of the statistical information table according to the first embodiment;

FIG. 6 is a view of an example of the sequence for stating new TCP communication after the mobile node switches the network connection to a different wireless network system, according to the first embodiment;

FIG. 7 is a view of an example of the format of a path update notification message according to the first embodiment;

FIG. 8 is a view of an example of the data structure of the mobile node information table according to the first embodiment;

FIG. 9 is a view of an example of the data structure of the new flow table according to the first embodiment;

FIG. 10 is a view of an example of the sequence for continuing the existing TCP communication after the mobile node switches the network connection of the wireless network system from WLAN to 3G;

FIG. 11 is a view of an example of the data structure of the rewrite flow table according to the first embodiment;

FIG. 12 is a view of an example of the sequence for completing the existing TCP communication after the mobile node switches the network connection of the wireless network system from WLAN to 3G according to the first embodiment;

FIG. 13 is a view of an example of the sequence for continuing the existing TCP communication after the mobile node switches the network connection of the wireless network system from 3G to WLAN according to the first embodiment;

FIG. 14 is an example of a flow chart of the process in which the service-network gateway receives and processes the path update notification message according to the first embodiment;

FIG. 15 is an example of a flow chart of the process in which the service-network gateway receives and processes the TCP communication packet according to the first embodiment;

FIG. 16 is an example of a flow chart of the process in which the service-network gateway rewrites the receive window size parameter (rwnd) of the ACK packet in the TCP communication according to the first embodiment; and

FIG. 17 is a view of an example of the format of the TCP header according to the first embodiment.

### DETAILED DESCRIPTION OF THE INVENTION

Hereinafter an embodiment of the present invention will be described with reference to the accompanying drawings. Note that the following description focuses on the use of TCP as the protocol of the packet communication, but the present invention is not limited to the TCP communication.

### Embodiment

As a first embodiment, a gateway device and a packet communication method for a packet communication system will be described, beginning with the system and then the process.

### <System>

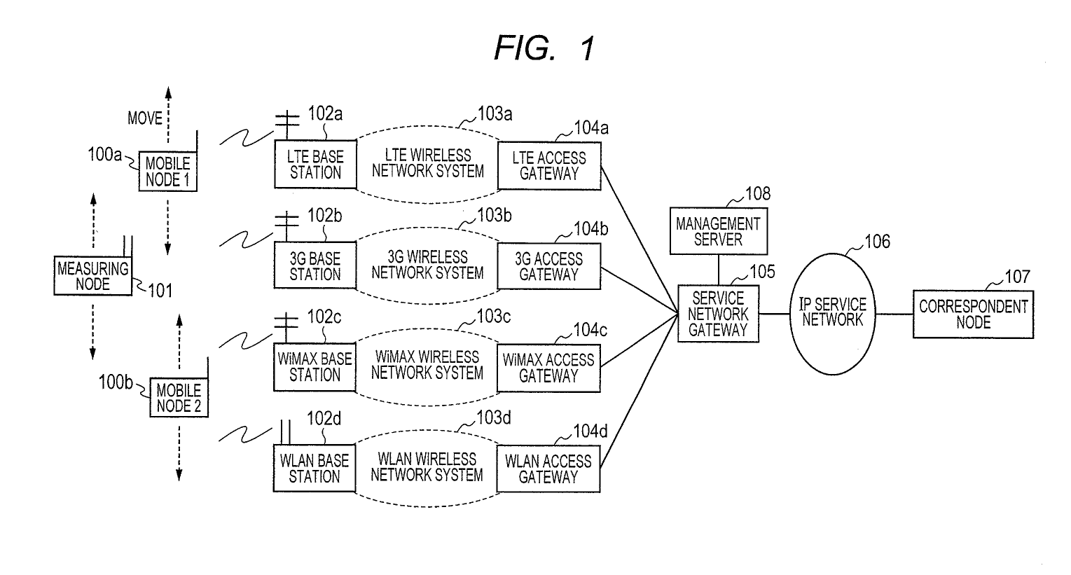

An example of the configuration of a packet communication system according to the present embodiment will be described with reference to FIG. 1. In FIG. 1, each of a first mobile node 100a, a second mobile node 100b, and a measurement node 101 includes a plurality of wireless interfaces. Each of the nodes performs wireless communication with an LTE base station 102a, a 3G base station 102b, a WiMAX base station 102c, or a WLAN base station 102d through the wireless interfaces, in order to convert a wireless signal to a wired signal. The LTE base station 102a is the base station of an LTE wireless network system 103a. Similarly, the 3G base station 102b is the base station of a 3G wireless network system 103b, the WiMAX base station 102c is the base station of a WiMAX wireless network system 103c, and the WLAN base station 102d is the base station of a WLAN wireless network system 103d.

The LTE wireless network system 103a performs packet communication with an external device through an LTE access gateway 104a. Similarly, the 3G wireless network system 103b performs packet communication with an external device through a 3G access gateway 104b. The WiMAX wireless network system 103c performs packet communication with an external device through a WiMAX access gateway 104c. The WLAN wireless network system 103d performs packet communication with an external device through a WLAN access gateway 104d. Each of the access gateways 104a to 104d performs packet communication with a service-network gateway 105.

The service-network gateway 105 transfers communication packets transmitted from the mobile node 100a or 100b, and the measurement node 101 to an appropriate IP service network 106. Further, the service-network gateway 105 transfers communication packets addressed to the mobile node 100a or 100b, and the measurement node 101 to the access gateway of the appropriate wireless network system. Mobile IP or General Packet Radio Service (GPRS) Tunneling Protocol (GTP) is used as the connection protocol between the service-network gateway 105 and each of the access gateways 104a to 104d.

The IP service network 106 is a network such as the Internet or an enterprise network. The correspondent node 107 is connected to the IP service network 106 to communicate with the mobile node 100a or 100b, end to end, through the packet communication system described above. Finally, a management server 108 performs packet communication with the service-network gateway 105 to configure the service-network gateway 105. Further, the management server 108 communicates with the measurement node 101, end to end, through the packet communication system described above.

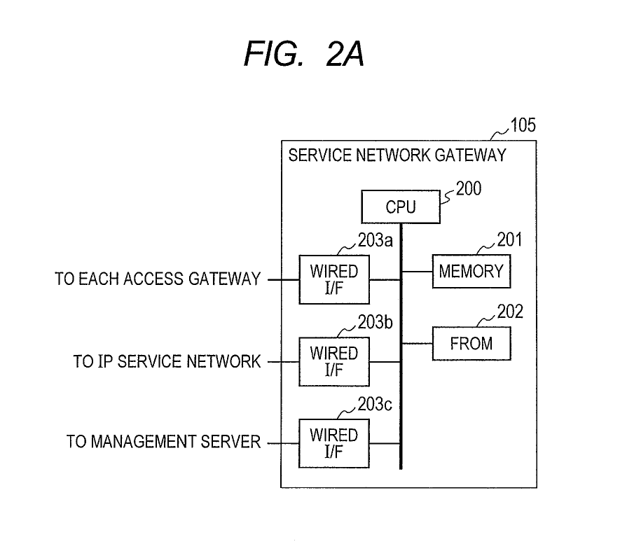

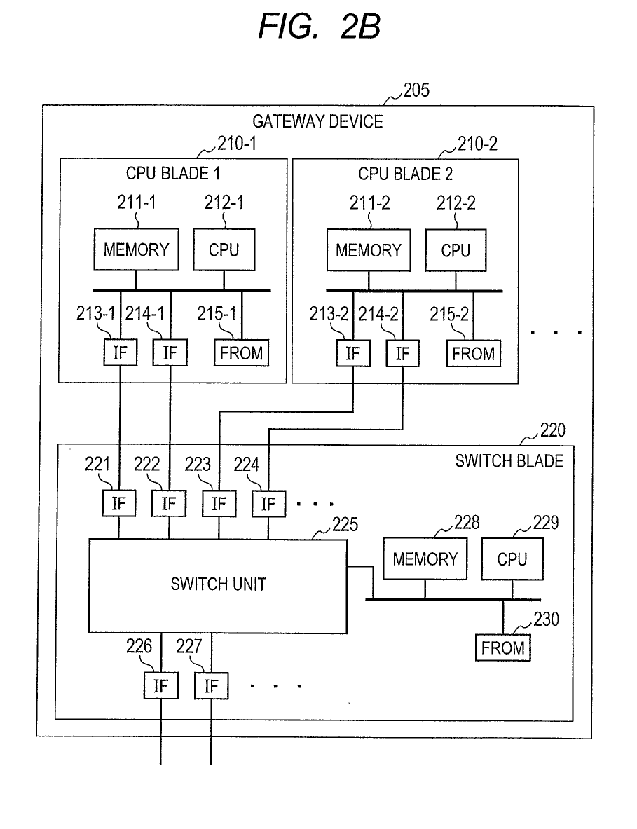

Next, a configuration of the service-network gateway of the present embodiment will be described with reference to FIGS. 2A and 2B. As shown in FIG. 2A, the service-network gateway 105 includes a central processing unit (CPU) 200 that serves as a processing unit, a memory 201 and a flash read only memory (FROM) 202 that serve as storage units, and a wired interface (I/F) that serves as an interface unit. In this configuration, the software program for providing the function as the service-network gateway is stored in the FROM 202. The software program is developed in the memory 201 when the device is started.

The CPU 200, which is the processing unit, sequentially reads the software program developed in the memory 201 and executes the program. The wired I/F 203a is connected to each of the access gateways 104a to 104d of the respective wireless network systems, to transmit and receive communication packets to and from each access gateway. The wired I/F 203b is connected to the IP service network 106 to transmit and receive communication packets to and from the other device connected to the IP service network. The wired I/F 203c is connected to the management server 108 to transmit and receive communication packets to and from the management server.

FIG. 2B shows an example of the detailed hardware configuration of the gateway device which is the service-network gateway 105. As shown in FIG. 2B, the gateway device 205 includes a plurality of CPU blades 210 for achieving signaling process and user traffic transfer process, and a switch blade 220 that functions with a layer-2 (L2) switch function. In this figure, the interfaces (I/F) 226, 227, and so on correspond to the wired I/Fs 203a, 203b, 203c shown in FIG. 2A. Further, CPUs 212-1, 212-2, 229 in each of the blades correspond to the CPU 200 in FIG. 2A, which share various processes. Similarly, the memories 211-1, 211-2, 228 correspond to the memory 201, and FROMs 215-1, 215-2, 230 correspond to the FROM 202. Note that reference numerals 213-1, 213-2, 214-1, 214-2, and 221 to 224, respectively, denote interfaces (I/F) between the blades. The following description uses the general configuration of the service-network gateway 105 shown in FIG. 2A.

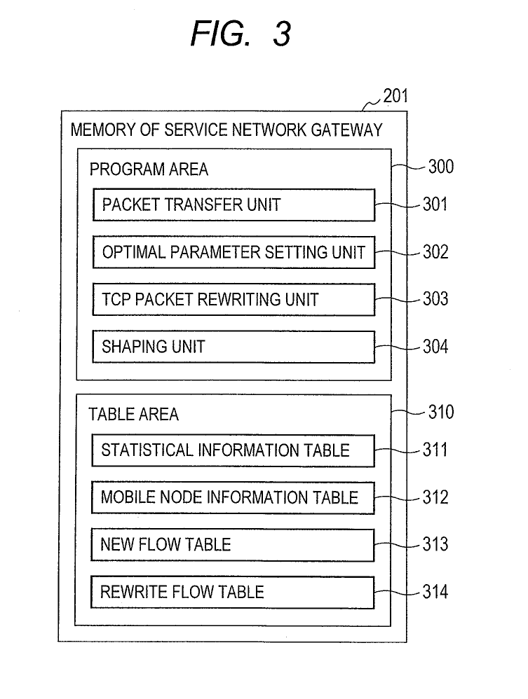

FIG. 3 is a view of the configuration of the software program and various tables, in which the software program is developed in the memory 201 of the service-network gateway of the present embodiment, and executed by the CPU 200 shown in FIG. 2A. A program area 300 and a table area 310 are formed in the memory 201.

The program area 300 includes different functional blocks including a packet transfer unit 301, an optimal parameter setting unit 302, a TCP packet rewriting unit 303, and a shaping unit 304. Each of the functional blocks is performed by the CPU 200 shown in FIG. 2A. In the configuration in FIG. 2B, it can be designed such that the CPU 229 executes the packet transfer unit 301, and the CPUs 212-1 and 212-2 execute the other functional blocks.

The packet transfer unit 301 transfers a communication packet addressed to the mobile node to the access system of the appropriate wireless network system. Then, the packet transfer unit 301 receives a communication packet transmitted from the mobile node, from the access gateway of each wireless network system. Then, the packet transfer unit 301 transfers the received communication packet to the appropriate IP service network. The optimal parameter setting unit 302 determines the optimal receive window size for the TCP communication performed between the mobile node and the correspondent node, as well as the optimal transmission rate of the communication packet addressed to the mobile node. The TCP packet rewriting unit 303 rewrites the receive window size of the ACK packet in the TCP communication transmitted from the mobile node, to the optimal parameter. The shaping unit 304 adjusts the transmission interval of the communication packet, when the transmission rate of the communication packet addressed to the mobile node exceeds the optimal transmission rate, by temporarily buffering the communication packet to obtain the optimal transmission rate.

The table area 310 includes various tables, including a statistical information table 311, a mobile node information table 312, a new flow table, and a rewrite flow table 314. The statistical information table 311 stores the statistical information on the bandwidth and the round trip time with respect to each of the wireless network systems. The mobile node information table 312 stores the connection information on the wireless network system to which the mobile node connects. The new flow table 313 stores the information of the TCP communication that is newly started after the mobile node switches the network connection to a different wireless network system. The rewrite flow table 314 stores the information of the TCP communication that has been performed before the mobile node switches the network connection to a different wireless network system, as well as the information of the TCP communication to store the optimal receive window size for the TCP communication. Note that the data structure of the individual tables will be described in detail below in the description of <Process (sequence)>.

The above is an example of the overall configuration of the packet communication system according to the present embodiment.

### <Process (Sequence)>

The service-network gateway of the present embodiment functions as the gateway device for relaying the communication packet by the operation of the CPU 200 included in the service-network gateway. In this case, the service-network gateway temporarily rewrites the receive window size parameter of the acquisition (ACK) packet of the TCP communication, to control the amount of transmission from the correspondent node. This process includes the following five steps: (A) a step of updating the statistical information table stored in the service-network gateway; (B) a step of starting new TCP communication after the mobile node switches the network connection to a different wireless network system; (C) a step of continuing the existing TCP communication after the mobile node switches the network connection of the wireless network system from WLAN to 3G; (D) a step of completing the existing TCP communication after the mobile node switches the network connection of the wireless network system from WLAN to 3G; and (E) a step of continuing the existing TCP communication after the mobile node switches the network connection of the wireless network system from 3G to WLAN.

(A) Step of Updating the Statistical Information Table Held by the Service-Network Gateway

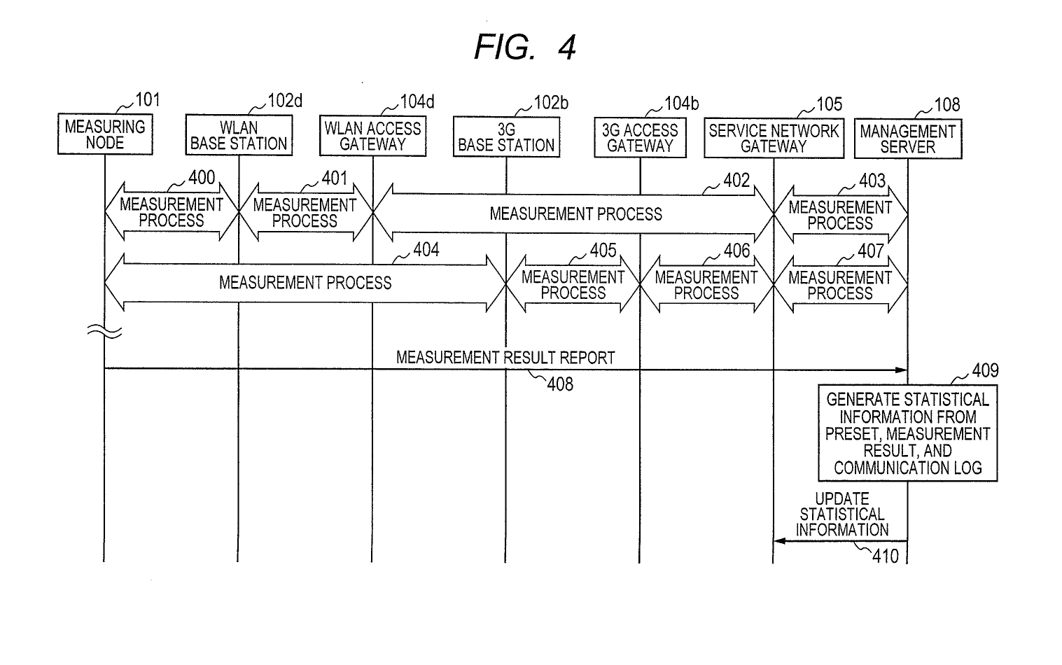

FIG. 4 is the procedure for updating the statistical information table 311 held by the service-network gateway 105. The measurement node 101 is connected to each wireless network system to perform packet communication with the management server 108. Then, the measurement node 101 measures the throughput and the round trip time (RTT). At this time, the usual tools such as iperf and ping are used for the measurement.

For example, with respect to the WLAN wireless network system, the measurement node 101 is connected to the WLAN base station 102d to perform measurement with the management server 108 through the WLAN access gate way 104d and the service-network gateway 105 (Steps 400 to 403). Further, for example, with respect to the 3G wireless network system, the measurement node 101 is connected to the 3G base station 102b to perform measurement with the management server 108 through the 3G access gateway 104b and the service-network gateway 105 (Steps 404 to 407). The measurement is performed in the same way for the other wireless network systems.

When a certain amount of measurements has been done, the measurement node 101 reports the measurement result to the management server 108 (Step 408). The report can be done online through one of the wireless network system, or off line by separately establishing the Ethernet (registered trademark) connection. The management server 108 generates statistical information by combining the preset previously set by the system administrator as the initial value, the reported measurement result, and the communication log in the measurement (Step 409). Then, the management server 108 transmits the generated statistical information to the service-network gateway, in order to update the statistical information table 311 held by the service-network gateway 105 (Step 410).

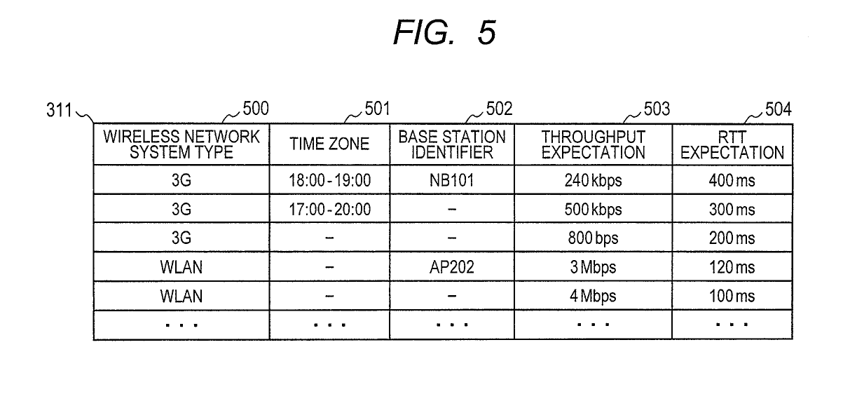

FIG. 5 is a view of an example of the data structure of the statistical information table 311 held by the service-network gateway 105. The statistical information table 311 contains the following items: wireless network system type 500, time zone 501, base station identifier 502, throughput expectation 503, and RTT expectation 504. For example, the first entry is the information on the wireless network system of 3G, in which the time zone measured by the measurement node is 18:00 to 19:00, the identifier of the 3G base station to which the measurement node connects is NB101, the expectation (for example, the measured average value) that is estimated from the measured value of the throughput is 240 kbps, and the expectation (for example, measured average value) that is estimated from the measured value of RTT is 400 ms. Further, the third entry is the information on the wireless network system of 3G, and the fifth entry is the information on the wireless network system of WLAN. The third and fifth entries indicate standard values (default data) that are independent of the time zone to be used and the base station to be connected. Here, only 3G and WLAN are shown as the wireless network system type 500 for convenience. However, similar statistical information is stored for other wireless network systems such as LTE and WiMAX.

In the packet communication system according to the present embodiment, the procedure for updating the statistical information shown in FIG. 4 is repeated at regular intervals. Thus, in addition to the static preset set by the administrator, the statistical information table can also be actively updated during the operation. Further, since the statistical information is held by the service-network gateway instead of by the individual mobile nodes, much more information can be collected. As a result, it is possible to reduce the load on the mobile node and the wireless network system, compared to the case of measuring and collecting information by each mobile node.

(B) Step of Starting New TCP Communication after the Mobile Node Switches the Network Connection to a Different Wireless Network System

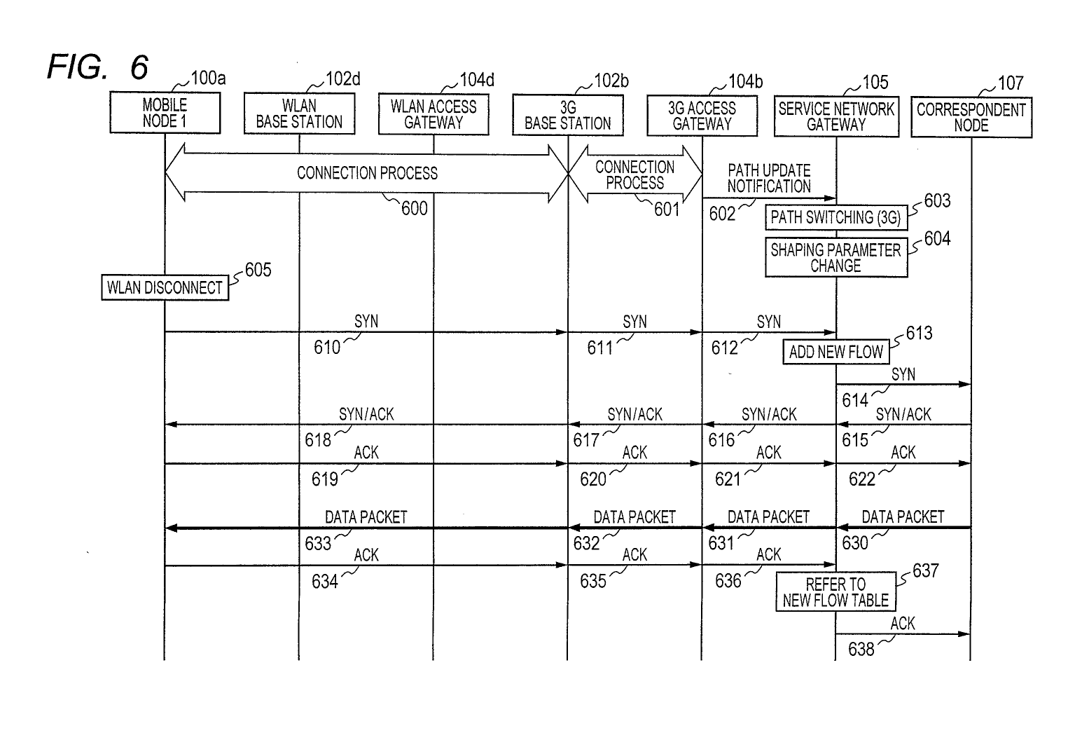

FIG. 6 is the procedure for starting new TCP communication after the mobile node switches the network connection to a different wireless network system in the packet communication system according to the present embodiment. Here, an example in which the mobile node switches the network connection of the wireless network system from WLAN to 3G is taken up. The first mobile node 100a performs a connection process for the 3G base station 102b (Step 600). At the same time, the control signal of the connection process for the mobile node 1 is communicated between the 3G base station 102b and the 3G access gateway 104b (Step 601). When the connection process is completed, the 3G access gateway transmits a path update notification message to the service-network gateway 105 (Step 602).

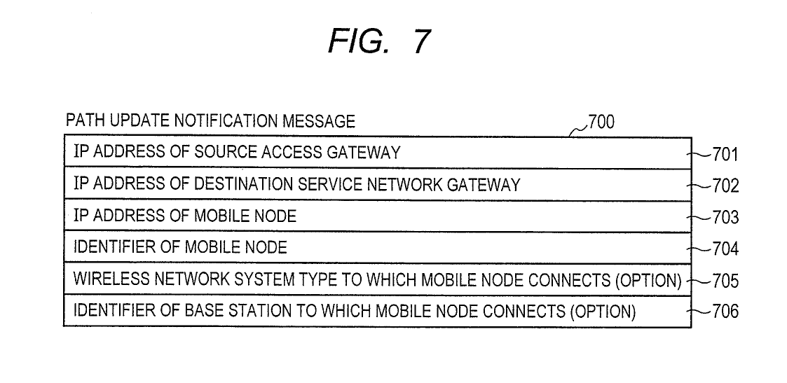

FIG. 7 is a view of an example of the configuration information of a path update notification message. A path update notification message 700 contains the following items: IP address 701 of the access gateway of the source of the message; IP address 702 of the service-network gateway of the destination of the message; IP address 703 assigned to the mobile node the performed the connection process; identifier 704 of the mobile node; wireless network system type 705 to which the mobile node connects; and base station identifier 706 to which the mobile node connects. The wireless network system type 705 to which the mobile node connects, as well as the base station identifier 706 to which the mobile node connects are options, so that they may not be added to the message. The path update notification message 700 is a part of the control message of the mobile IP or GTP which is a connection protocol between each access gateway and the service-network gateway.

Returning to FIG. 6, in which the CPU 200 of the service-network gateway 105 receives the path update notification message of Step 602. Then, the CPU 200 of the service-network gateway 105 updates the connection information by referring to the mobile node information table 312 shown in FIG. 3, with the mobile node identifier 704 of the message as an index.

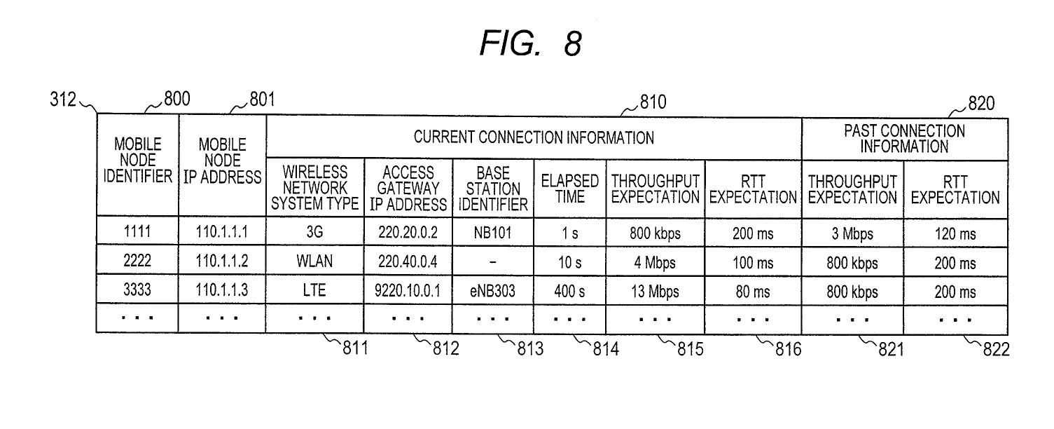

FIG. 8 is a view of an example of the data structure of the mobile node information table 312. The mobile node information table 312 contains the following items: mobile node identifier 800, mobile node IP address 801, current connection information 810, and past connection information 820. Further, the current connection information 810 contains the following sub items: wireless network system type 811; IP address 812 of the access gateway of the wireless network system to be connected; identifier 813 of the base station to be connected; elapsed time 814 from the switching of the wireless network system; throughput expectation 815 of the wireless network system to be connected; and RTT expectation 816 of the wireless network system to be connected. Further, the past connection information 820 contains the following sub items: throughput expectation 821 of the wireless network system that is connected before the switching of the wireless network system; and RTT expectation 822 of the wireless network system that is connected before the switching of the wireless network system.

For example, it is assumed that the identifier of the first mobile node 100a is 1111. In this case, the method of updating the entry upon receiving the path update notification message will be described. With respect to the first entry, the mobile node IP address 801 stores the IP address 703 of the mobile node of the path update notification message. The current wireless network system type 811 stores the wireless network system type 705 to which the mobile node of the path update notification message connects. Alternatively, it stores the wireless network system type that is determined by the IP address 701 of the access gateway of the source. The current access gateway IP address 812 stores the IP address 701 of the access gateway of the source. The current base station identifier 813 stores the base station identifier 706 to which the mobile node of the path update notification message connects. The current elapsed time 814 is the time from when the path update notification message is received, which is updated for every reference. The current throughput expectation 815 and the currents RTT expectation 816 store information obtained by referring to the statistical information table 311 based on the current wireless network system type 811, the current time, and the current base station identifier 813.

For example, when the wireless network system type is 3G, the current time is 1200, and the current base station is NB101, the information matches the third entry (default data) with reference to the statistical information table 311 shown in FIG. 5. At this time, the throughput expectation 503 is obtained as 800 kbps and the RTT expectation 504 is obtained as 200 ms. The obtained values are stored in the current throughput expectation 815 and the current RTT expectation 816, respectively, in the mobile node information table. The past throughput expectation 821 and the past RTT expectation 822 store information obtained by copying the values, respectively, stored in the current throughput expectation 815 and the current RTT expectation 816 before the reception of the path update notification message. Thus, in the case of this example, the throughput expectation and the RTT expectation, which are the expectation values when the mobile node 1 connects to WLAN before switching the wireless network system, are stored. The entry for the mobile node 1 is updated by the procedure described above.

Returning to FIG. 6, in which the CPU 200 of the service-network gateway 105 receives the path update notification message of Step 602, and updates the mobile node information table 312. Then, the CPU 200 switches the transfer path of the communication packet addressed to the mobile node 1, to the 3G access gateway (Step 603). Then, the CPU 200 changes the parameter of the shaping (also referred to as pacing) function included in the service-network gateway (Step 604). The shaping function is the function to transfer communication packets by controlling the transmission interval, when a large amount of communication packets addressed to the mobile node are instantaneously received, by buffing the received communication packets to adjust the transmission interval to a predetermined transmission rate. This is done by a shaping execution unit 304. In this way, it is possible to prevent the packet loss due to the input of a large amount of communication packets exceeding the capacity of the wireless network system.

The parameter of the shaping function is the predetermined transmission rate described above. The service-network gateway 105 sets the current throughput expectation 815 of the mobile node information table 312 as the parameter. In this way, it is possible to select the parameter of the optimal shaping function according to the wireless network system to which the mobile node connects, and thus prevent the packet loss. Then, the mobile node 1 disconnects WLAN (Step 605).

Next, the mobile node 1 transmits an SYN packet, which is addressed to the correspondent node 107, to the 3G base station to start new TCP communication with the correspondent node 107 (Step 610). The SYN packet is the communication packet that means a TCP communication start request with the SYN flag set in the TCP header. The SYN packet arrives at the service-network gateway 105 through the 3G base station and the 3G access gateway (Steps 611, 612). Upon receiving the SYN packet, the service-network gateway 105 extracts the IP address and port number of the mobile node 100a as well as the IP address and port number of the correspondent node 107, which are described in the SYN packet. Then, the service-network gateway 105 adds an entry to the new flow table 313.

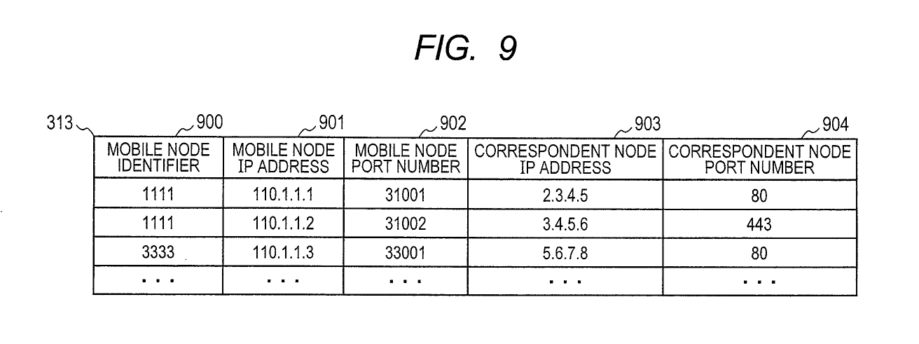

FIG. 9 is a view of an example of the data structure of the new flow table 313 shown in FIG. 3. The new flow table 313 contains the following items: mobile node identifier 900, mobile node IP address 901, mobile node port number 902, correspondent node IP address 903, and correspondent node port number 904. For example, the first entry represents a new TCP communication flow for the mobile node 100a, in which the mobile node identifier is 1111, the mobile node IP address is 110.1.1.1, the mobile node port number is 31001, the correspondent node IP address is 2.3.4.5, and the correspondent node port number is 80. The mobile node identifier 900 stores information obtained by referring to the mobile node information table 312 based on the mobile node IP address 901. The other items store information extracted from the SYN packet.

Returning to FIG. 6, after Step 613, the service-network gateway 105 transfers the SYN packet to the correspondent node 107 (Step 614). In response to the SYN packet, the correspondent node 107 returns an SYN/ACK packet addressed to the mobile node 100a (Step 615). The SYN/ACK packet is the communication packet that means a TCP communication start response with the SYN and ACK flags set in the TCP header. The SYN/ACK packet arrives at the mobile node 100a through the service-network gateway 105, the 3G access gateway 102b, and the 3G base station 102b (Steps 616 to 618). In response to the SYN/ACK packet, the mobile node 100a returns an ACK packet addressed to the correspondent node 107 (Step 619). The ACK packet is the communication packet that means a response with the ACK flag set in the TCP header. The ACK packet arrives at the correspondent node 107 through the 3G base station 102b, the 3G access gateway 104b, and the service-network gateway 105 (Steps 620 to 622). Thus, the TCP session is established between the mobile node 100a and the correspondent node 107 by the procedure of steps 610 to 622.

Then, the correspondent node 107 transmits a data packet to the mobile node 100a by the established TCP session (Step 630). The data packet arrives at the mobile node 100a through the service-network gateway, the 3G access gateway, and the 3G base station (Steps 631 to 633). The mobile node 100a receives the data packet, and returns the ACK packet (Step 634). The ACK packet arrives at the service-network gateway 105 through the 3G base station and the 3G access gate way (Steps 635, 636). Upon receiving the ACK packet, the service-network gateway 105 extracts the IP address and port number of the mobile node 100a as well as the IP address and port number of the correspondent node 107, which are described in the ACK packet. Then, the service-network gateway 105 refers to the new flow table 313 shown in FIG. 9 (Step 637). Here, the information matches the first entry. When the matching entry is found in the new flow table 313, the service-network gateway 105 transfers the ACK packet to the correspondent node 107, without rewiring the information of the ACK packet (Step 638).

By the procedure described above, in the packet communication system according to the present embodiment, the service-network gateway avoids rewriting the parameters of the ACK packet in the TCP communication from the mobile node, when the TCP communication is newly started after the mobile node switches the network connection to a different wireless network system.

(C) Step of Continuing the Existing TCP Communication after the Mobile Node Switches the Network Connection of the Wireless Network System from WLAN to 3G

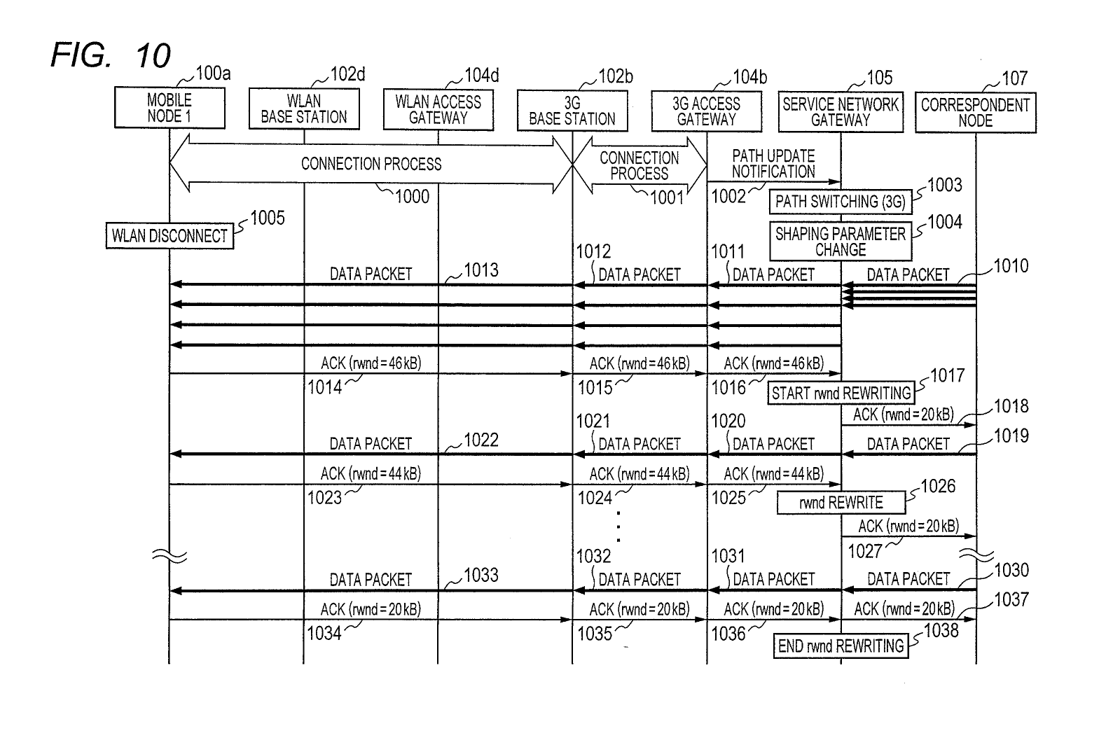

FIG. 10 is the procedure for continuing the existing TCP communication after the mobile node switches the network connection of the wireless network system from WLAN to 3G. Here, an example that the mobile node 1 switches the network connection from WLAN to 3G is taken up. The same procedure as shown in FIG. 10 is used when the mobile node switches from a wireless network system with a large bandwidth-delay product obtained by multiplying the throughput expectation and the RTT expectation to a wireless network system with a small bandwidth-delay product. In general, LTE, WiMAX, and WLAN are wireless network systems with a relatively large bandwidth-delay product, while 3G is a wireless network system with a relatively small bandwidth-delay product. Which one of the LTE, WiMAX, and WLAN has the largest bandwidth-delay product depends on the connection situation.

Steps 1000 to 1005 are the same as Steps 600 to 605 of FIG. 6, so that the description thereof will be omitted here.

The correspondent node 107 transmits data packets by using the TCP session established before the mobile node 100a switches the network connection of the wireless network system to 3G (Step 1010). At this time, the correspondent node 107 may not know the fact that the mobile node 100a switches the network connection of the wireless network system from WLAN to 3G. Thus, the correspondent node 107 is still transmitting a large amount of data packets for the 3G wireless network system, although it is the normal amount for the WLAN wireless network system. Upon receiving the data packets, the service network getaway 105 transfers the received data packets by adjusting the transmission interval to the shaping parameter set in Step 1004, namely, adjusting the transmission interval to meet the throughput expectation of the 3G wireless network system, by the shaping function of the shaping execution unit 304 (Step 1011). The data packets arrive at the mobile node 100a through the 3G access gateway and the 3G base station (Steps 1012, 1013). In this way, it is possible to reduce the possibility of the packet loss in the wireless network system, when a large amount of packets are instantaneously transmitted in the packet communication system according to the present embodiment.

The mobile node 100a receives the data packets, and transmits an ACK packet as a response (Step 1014). The receive window size (rwnd) that indicates the maximum number of packet bytes that the mobile node 1 wants to receive at a time is described as a parameter in the TCP header of the ACK packet.

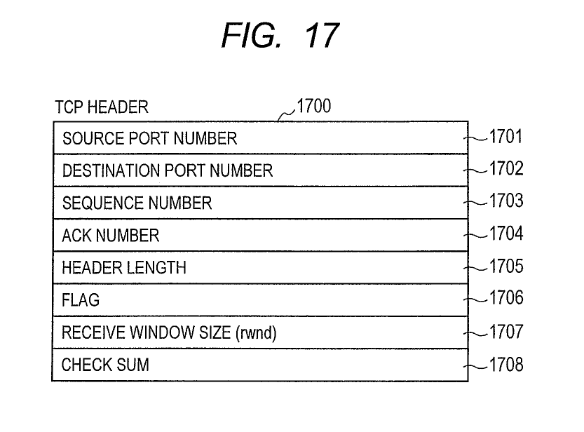

FIG. 17 is a view of an example of the format of a TCP header. A TCP header 1700 has, as parameters, a port number 1701 used by the source node, a port number 1702 used by the destination node, a sequence number 1703 indicating the number of transmitted data bytes, an ACK number 1704 indicating the number of received data bytes, a header length 1705 of the TCP header, a flag 1706 such as SYN flag or ACK flag, a receive window size (rwnd) 1707, and a check sum 1708 for the entire TCP header.

The mobile node 100a can notify the correspondent node 107 of the receive window size, as a parameter, by using the ACK packet. The correspondent node 107 can transmit data packets of the TCP communication only for the particular receive window size until the next ACK packet is received from the mobile node. In other words, the receive window size serves as the upper limit of the number of data bytes that can be transmitted from the correspondent node at a time. In theory, in the TCP communication, when the receive window size is set to the bandwidth-delay product that is obtained by multiplying the throughput and RTT between the mobile node and the correspondent node, the packet loss can be reduced to the smallest value and the communication band can be effectively used.

Thus, when the mobile node performs communication by connecting to WLAN, the receive window size is relatively large. On the other hand, when the mobile node performs communication by connecting to 3G, the receive window size is relatively small. The TCP stack of some operating systems (OS) has the function of automatically adjusting the receive window size. However, it is necessary to continue the communication for a while to measure the throughput and the RTT. For this reason, it is difficult for the mobile node to set the appropriate receive window size quickly, even when the mobile node switches the network connection to a different wireless network system.

As shown in FIG. 10, the receive window size (rwnd) described in the ACK packet of Step 1014 is 46 K bytes. This is the receive window size used when the mobile node 100a connects to the WLAN wireless network system. The ACK packet transmitted from the mobile node 100a arrives at the service-network gateway 105 through the 3G base station and the 3G access gateway (Steps 1015, 1016). Upon receiving the ACK packet, the service-network gateway 105 extracts the IP address and port number of the mobile node 100a as well as the IP address and port number of the correspondent node 107, which are described in the ACK packet. Then, the service-network gateway 105 adds an entry to the rewrite flow table 314.

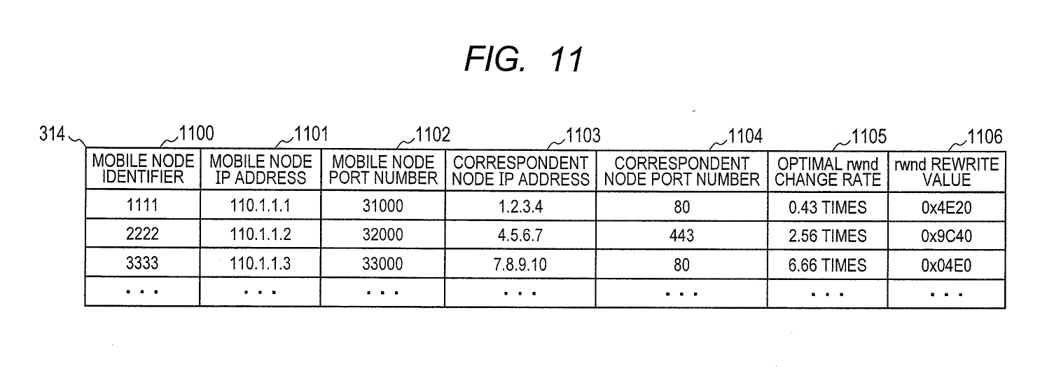

FIG. 11 is a view of an example of the data structure of the rewrite flow table 314. As shown in the figure, the rewrite flow table 314 contains the following items: mobile node identifier 1100, mobile node IP address 1011, mobile node port number 1102, correspondent node IP address 1103, correspondent node port number 1104, change rate 1105 of the optimal receive window size (rwnd) before and after the mobile node switches the network connection of the wireless network system, and value 1106 by which the receive window size (rwnd) parameter in the ACK packet is actually rewritten. The mobile node identifier 1100 stores information that is obtained by referring to the mobile node information table 312 shown in FIG. 8, based on the mobile node IP address 1101. The items 1101 to 1104 store information extracted from the ACK packet, respectively.

The optimal rwnd change rate 1105 is obtained from the equation “(the current throughput expectation 815×the current RTT expectation 816)/(the past throughput expectation 821×the past RTT expectation 822)”, with reference to the entry for the target mobile node in the mobile node information table 312 shown in FIG. 8. This calculation is performed by the optimal parameter setting unit 302. The rwnd rewrite value 1106 is calculated by multiplying the value of the receive window size described in the ACK packet received in Step 1016 of FIG. 10, by the optimal rwnd change rate 1105. This calculation is also performed by the optimal parameter setting unit 302. As described above, the rewrite value is calculated by multiplying by the optimal rwnd change rate. Thus, it is possible to use the receive window size parameter described in the ACK packet also for the TCP scaling option, making the receive window size parameter described in the ACK packet, a power of two smaller than the actual receive window size. Further, the upper limit is set for the case of the optimal rwnd change rate exceeding a certain value. If the correspondent node transmits communication packets that are several times greater than the current receive window size, the mobile node may not receive all the communication packets transmitted from the correspondent node. In most cases, it is preferable that the upper limit of the optimal rwnd change rate is about twice the receive window size.

As described above, the entry is generated in the rewrite flow table 314. For example, the first entry indicates the TCP communication flow for the mobile node 100a, in which the mobile node identifier is 1111, the mobile node IP address is 110.1.1.1, the mobile node port number is 31000, the correspondent node IP address is 1.2.3.4, the correspondent node port number is 80, the optimal rwnd change rate is 0.43 times, and the rwnd rewrite value is 0x4E20 (hexadecimal number).

Returning to FIG. 10, in which the CPU 200 of the service-network gateway 105 executes the TCP packet rewriting unit 303 to add the entry to the rewrite flow table 314. Then, the CPU 200 starts rewriting the receive window size parameter of the ACK packet received in Step 1016, by the calculated rewrite value (Step 1017). Here, the rewrite value is 20 K bytes. The service-network gateway 105 transfers the rewritten ACK packet to the correspondent node 107 (Step 1018). Upon receiving the ACK packet, the correspondent node 107 transmits again the data packet addressed to the mobile node 100a (Step 1019). At this time, the receive window size parameter of the ACK packet received in Step 1018 is small, so that the amount of transmitted data packets is smaller than before. In this way, it is possible to prevent a situation where a large amount of data packets arrives at the service-network gateway several times, resulting in the packet loss due to the exhaustion of the buffer of the service-network gateway.

The data packet transmitted from the correspondent node 107 arrives at the mobile node 100a through the service-network gateway, the 3G access gateway, and the 3G base station (Steps 1020 to 1022). The mobile node 100a receives the data packet, and transmits again the ACK packet addressed to the correspondent node 107 (Step 1023). At this time, the receive window size, which is slightly reduced by the automatic adjustment to 44 K bytes. The ACK packet arrives at the service-network gateway 105 through the 3G base station and the 3G access gateway 105 (Steps 1024, 1025). The CPU 200 of the service-network gateway 105 executes the TCP packet rewriting unit 303 to extract the IP address port umber of the mobile node 100a as well as the IP address number of the correspondent node 107, which are described in the ACK packet. Then, the CPU 200 refers to the rwnd rewrite value 1106 by referring to the entry of the rewrite flow table 314 shown in FIG. 11. Then, the CPU 200 rewrites the receive window size parameter of the ACK packet by the rwnd rewrite value (Step 1026). The service-network gateway 105 transfers the rewritten ACK packet to the correspondent node 107 by the function of the packet transfer unit 301 (Step 1027). Then, the same procedure as the procedure of Steps 1019 to 1027 is executed for a while.

Then, the data packet addressed to the mobile node 100a is transmitted from the correspondent node 107 in the same way as Steps 1019 to 1022 (Steps 1030 to 1033). Upon receiving the data packet, the mobile node 100a transmits again the ACK packet addressed to the correspondent node 107 (Step 1034). At this time, the receive window size is adjusted to 20 K bytes by automatic adjustment. The ACK packet arrives at the service-network gateway 105 through the 3G base station and the 3G access gateway (Steps 1035, 1036). The service-network gateway 105 extracts the IP address and port number of the mobile node 1 as well as the IP address and port number of the correspondent node 107, which are described in the ACK packet. Then, the service-network gateway 105 refers to the rwnd rewrite value 1106 by referring to the entry of the rewrite flow table 314 shown in FIG. 11. Here, the value of the receive widow size parameter of the ACK packet is not more than the rwnd rewrite value, so that the service-network gateway 105 transfers the ACK packet as it is, without any rewriting, to the correspondent node 107 (Step 1037). Finally, the service-network gateway 105 deletes the reference entry of the rewrite flow table 314, and ends the rewrite process of the receive window size parameter by the TCP packet rewriting unit 303 (Step 1038).

In the procedure described above, it is assumed that the TCP stack of the mobile node 100a automatically adjusts the receive window size. However, as described above, the receive window size is not automatically adjusted by the OS. In this case, the service-network gateway 105 refers to the current elapsed time 814 of the mobile node information table 312 in the rewriting process of the receive window size of the ACK packet. If a predetermined time has passed since the network connection has been switched, the service-network gateway 105 may delete all the entries in the TCP communication flow of the mobile node 100a from the new flow table 312 and the rewrite flow table 314, and end the rewriting process of the receive window size parameter. For example, the predetermined time is determined by adding twice the standard deviation to the average continuous time of the TCP communication. In this way, the effect of the packet communication system according to the present embodiment can be expected for the TCP communication of 95% or more.

By the procedure described above, in the packet communication system according to the present embodiment, it is possible to prevent the degradation of the performance due to error control for the existing TCP communication with respect to the mobile node, when the mobile node switches the network connection to a different wireless network system, without converting the mobile node and the correspondent node. As a result, the TCP communication can be stabilized. In addition, the service-network gateway rewrites the receive window size parameter of the ACK packet in the TCP communication from the mobile node not constantly but temporarily, so that it is possible to prevent the service-network gateway from constantly wasting resources.

(D) Step of Completing the Existing TCP Communication after the Mobile Node Switches the Network Connection of the Wireless Network System from WLAN to 3G

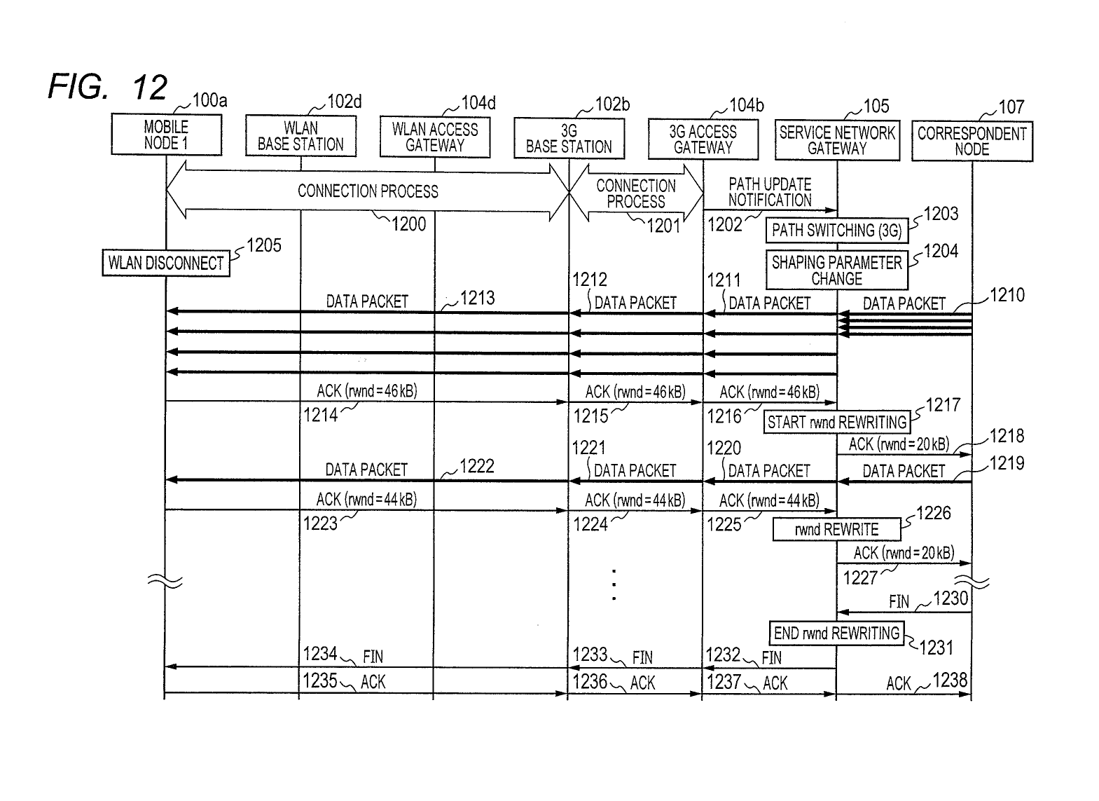

FIG. 12 is a procedure for completing the existing TCP communication in the packet communication system according to the present embodiment, after the mobile node 100a switches the network connection of the wireless network system from WLAN to 3G and then the TCP communication is continued for a while. Here, an example that the mobile node 100a switches the network connection from WLAN to 3G is taken up. However, the same procedure as shown in FIG. 12 is used when the mobile node 100a switches from a wireless network system with a large bandwidth-delay product obtained by multiplying the throughput expectation and the RTT expectation to a wireless network system with a small bandwidth-delay product.

Steps 1200 to 1227 are the same as Steps 1000 to 1027 shown in FIG. 10, so that the description thereof will be omitted here.

After the TCP communication is continued for a while, the correspondent node transmits an FIN packet addressed to the mobile node 100a in order to complete the TCP communication (Step 1230). The FIN packet is the communication packet that means a TCP communication end request with the FIN and ACK flags set in the TCP header. The service-network gateway 105 extracts the IP address and port number of the mobile node 100a as well as the IP address and port number of the correspondent node 107, which are described in the FIN packet. Then, the service-network gateway 105 refers to the entry of the rewrite flow table 314 shown in FIG. 11 deletes the particular entry, and ends the rewriting process of the receive window size parameter (Step 1231). The service-network gateway 105 transfers the FIN packet to the 3G access gateway (Step 1232). The FIN packet arrives at the mobile node 100a through the 3G access gateway and the 3G base station (Steps 1233, 1234). The mobile node 100a receives the FIN packet, and transmits the ACK packet addressed to the correspondent node 107 (Step 1235). The ACK packet arrives at the service-network gateway 105 through the 3G base station and the 3G access gateway (Steps 1236, 1237). The service-network gateway 105 transfers the ACK packet as it is, without any rewriting, to the correspondent node 107 (Step 1238).

By the procedure described above, in the packet communication system according to the present embodiment, it is possible to prevent the degradation of the performance due to error control for the existing TCP communication with respect to the mobile node when the mobile node switches the network connection to a different wireless network system without converting the mobile node and the correspondent node. As a result, the TCP communication can be stabilized and completed. In addition, the service-network gateway rewrites the receive window size parameter of the ACK packet in the TCP communication from the mobile node not constantly but temporarily, so that it is possible to prevent the service-network gateway from constantly wasting resources.

(E) Step of Continuing the Existing TCP Communication after the Mobile Node Switches the Network Connection of the Wireless Network System from 3G to WLAN

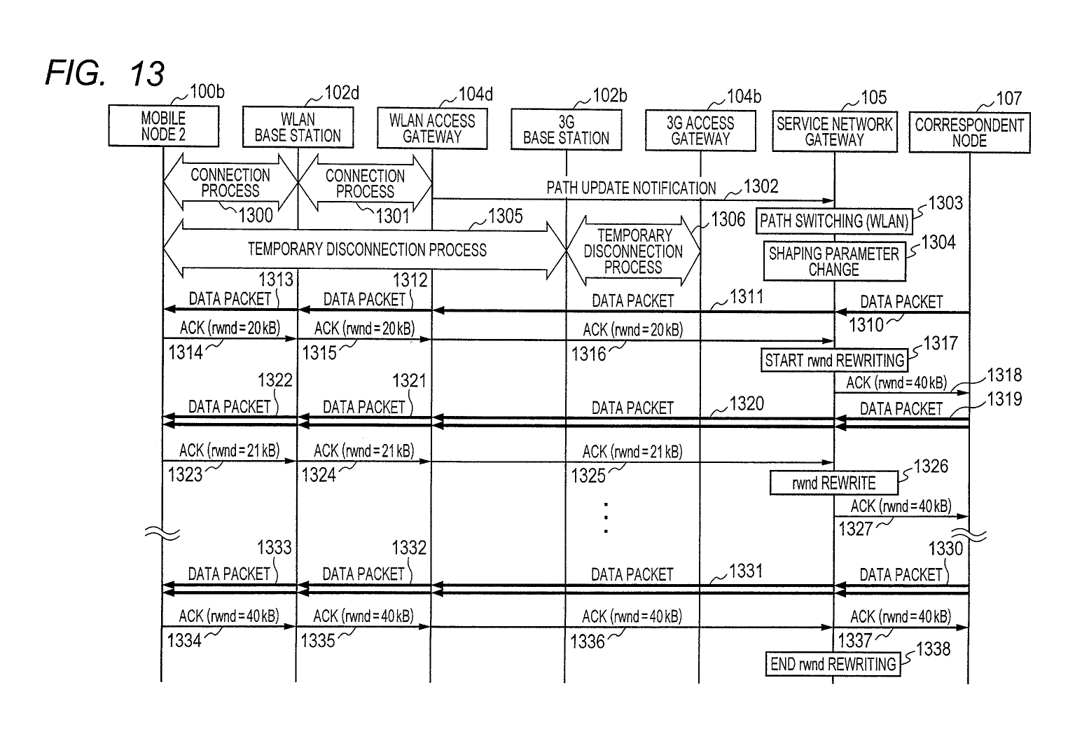

FIG. 13 is the procedure for continuing the existing TCP communication after the second mobile node 100b switches the network connection of the wireless network system from 3G to WLAN in the packet communication system according to the present invention. Here, an example that the mobile node 100b switches the network connection from 3G to WLAN is taken up. However, the same procedure as shown in FIG. 13 is used when the mobile node 100b switches from a wireless network system with a small bandwidth-delay product obtained by multiplying the throughput expectation and the RTT expectation to a wireless network system with a large bandwidth-delay product.

The mobile node 100b performs a connection process for the WLAN base station 102d (Step 1300). At the same time, the control signal of the connection process for the mobile node 100b is communicated between the WLAN base station and the WLAN access gateway 104d (Step 1301). After the completion of the connection process, the WLAN access gateway transmits a path update notification message to the service-network gateway 105 (Step 1302). Upon receiving the path update notification message, the service-network gateway 105 updates the connection information by referring to the mobile node information table 312 with the mobile node identifier 704 in the message being used as the index.

The second entry of the mobile node information table 312 shown in FIG. 8 is of the mobile node 100b. The mobile node identifier is 2222, the mobile node IP address is 110.1.1.2, the currently connected wireless network system type is WLAN, the IP address of the access gateway of the currently connected wireless network system is 220.40.0.4, the identifier of the currently connected base station is unknown, the elapsed time from the reception of the path update notification message is 10 s, the throughput expectation of the currently connected wireless network system is 4 Mbps, the RTT expectation of the currently connected wireless network system is 100 ms, the throughput expectation of the wireless network system before switching is 800 kbps, and the RTT expectation of the wireless network system before switching is 200 ms.

Returning to FIG. 13, in which the service-network gateway 105 receives the path update notification message of Step 1302, and updates the mobile node information table 312. Then, the service-network gateway 105 switches the transfer path of the communication packet addressed to the mobile node 100b to the WLAN access gateway 104d (Step 1303). Then, the service-network gateway 105 changes the parameter of the shaping function included in the service-network gateway 105 (Step 1304). The service-network gateway 105 sets the current throughput expectation 815 of the mobile node information table 312 as the parameter. In this way, the parameter of the optimal shaping function can be selected according to the wireless network system to which the mobile node 100b connects, in order to effectively use the wireless bandwidth. Then, the mobile node 100b performs a temporary disconnection process for the 3G base station (Step 1305). At the same time, the control signal of the temporary disconnection process for the mobile node 100b is communicated between the 3G base station and the 3G access gateway (Step 1306).

The correspondent node 107 transmits data packets by using the TCP session established before the mobile node 100b switches the network connection of the wireless network system to WLAN (Step 1310). At this time, the correspondent node 107 may not know the fact that the mobile node 100b switches the network connection of the wireless network system from 3G to WLAN. Thus, the correspondent node 107 is still transmitting a small amount of data packets for the WLAN wireless network system, although it is the normal amount for the 3G wireless network system. At this time, the service-network gateway has no need to perform the shaping function because the amount of data packets is small. The data packets arrive at the mobile node 100b through the service-network gateway, the WLAN access gateway, and the WLAN base station (Steps 1311 to 1313).

The mobile node 100b receives the data packets, and transmits an ACK packet as a response (Step 1314). The receive window size (rwnd) described in the ACK packet is 20 K bytes. This is the receive window size used when the mobile node 100b connects to the 3G wireless network system. The ACK packet transmitted from the mobile node 100b arrives at the service-network gateway 105 through the WLAN base station 102d and the WLAN access gateway 104d (Steps 1315, 1316). Upon receiving the ACK packet, the service-network gateway 105 extracts the IP address and port number of the mobile node 100b as well as the IP address and port number of the correspondent node 107, which are described in the ACK packet. Then, the service-network gateway 105 adds an entry to the rewrite flow table 314.

The second entry of the rewrite flow table 314 shown in FIG. 11 indicates the TCP communication flow for the mobile node 100b. The mobile node identifier is 2222, the mobile node IP address is 110.1.1.2, the mobile node port number is 32000, the correspondent node IP address is 4.5.6.7, the correspondent node port number is 443, the optimal rwnd change rate is 2.56 times, and the rwnd rewrite value is 0x9C40 (hexadecimal number). Here, since the optimal rwnd is more than twice, the rwnd rewrite value is calculated by multiplying the value of the receive window size described in the ACK packet received in Step 1316 of FIG. 13, by two times the upper limit.

Returning to FIG. 13, after the entry is added to the rewrite flow table 314, the service-network gateway 105 starts rewriting the receive window size parameter of the ACK packet received in Step 1316 by the calculated rewrite value (Step 1317). Here, the rewrite value is 40 K bytes. The service-network gateway 105 transfers the rewritten ACK packet to the correspondent node 107 (Step 1318). The correspondent node 107 receives the ACK packet, and transmits again data packets addressed to the mobile node 100b (Step 1319). At this time, the receive window size parameter of the ACK packet received in Step 1318 is large, so that the amount of transmitted data packets here is greater than before. In this way, it is possible to effectively use the WLAN throughput quickly, even when the mobile node 100b switches the network connection of the wireless network system to WLAN.

The data packets transmitted from the correspondent node 107 arrive at the mobile node 100b through the service-network gateway 105, the WLAN access gateway 104d, and the WLAN base station 102d (Steps 1320 to 1322). The mobile node 100b receives the data packets, and transmits again the ACK packet addressed to the correspondent node 107 (Step 1323). At this time, the receive window size is slightly increased by the automatic adjustment to 21 K bytes. The ACK packet arrives at the service-network gateway 105 through the WLAN base station 102d and the WLAN access gateway 104d (Steps 1324, 1325). The service-network gateway 105 extracts the IP address and port number of the mobile node 100b as well as the IP address and port number of the correspondent node 107, which are described in the ACK packet. Then, the service-network gateway 105 refers to the rwnd rewrite value 1106 by referring to the entry of the rewrite flow table 314. Then, the service-network gateway 105 rewrites the receive window size parameter of the ACK by the rwnd rewrite value (Step 1326). The service-network gateway 105 transfers the rewritten ACK packet to the correspondent node 107 (Step 1327). Then, the same procedure as the procedure of Steps 1319 to 1327 is executed for a while.

Then, the correspondent node 107 transmits data packets addressed to the mobile node 100b in the same way as in Steps 1319 to 1322 (Steps 1330 to 1333). The mobile node 100b receives the data packets, and transmits again the ACK packet addressed to the correspondent node (Step 1334). At this time, the receive window size is adjusted to 40 K bytes by the automatic adjustment. The ACK packet arrives at the service-network gateway 105 through the WLAN base station 102d and the WLAN access gateway 104d (Steps 1335, 1336). The service-network gateway 105 extracts the IP address and port number of the mobile node 100b as well as the IP address and port number of the correspondent node 107, which are described in the ACK packet. Then, the service-network gateway 105 refers to the rwnd rewrite value 1106 by referring to the entry of the rewrite flow table 314 shown in FIG. 11. At this time, the value of the receiving window parameter of the ACK packet is not less than the rwnd rewrite value. Thus, here the service-network gateway 105 transfers the ACK packet as it is, without any rewriting, to the correspondent node 107 (Step 1337). Finally, the service-network gateway 105 deletes the reference entry of the rewrite flow table 314, and ends the rewriting process of the receive window size parameter (Step 1338).

In the above procedure, it is assumed that the TCP stack of the mobile node 100b automatically adjusts the receive window size. However, as described above, the receive window size is not automatically adjusted by the OS. In this case, the service-network gateway 105 refers to the current elapsed time 814 of the mobile node information table 312 in the rewriting process of the receive window size of the ACK packet. If a predetermined time has passed since the network connection has been switched, the service-network gateway 105 may delete all the entries of the TCP communication flow for the mobile node 100a from the new flow table and from the rewrite flow table, and end the rewriting process of the receive window size parameter. For example, the predetermined time is determined by adding twice the standard deviation to the average continuous time of the TCP communication. In this case, the effect of the packet communication system according to the present embodiment can be expected for the TCP communication of 95% or more.

By the procedure described above, in the packet communication system according to the present embodiment, it is possible to prevent the degradation of the performance due to error control for the existing TCP communication with respect to the mobile node, when the mobile node switches the network connection to a different wireless network system, without converting the mobile node and the correspondent node. As a result, the efficiency of the TCP communication can be increased. In addition, the service-network gateway rewrites the receive window size parameter of the ACK packet in the TCP communication from the mobile node not constantly but temporarily, so that it is possible to prevent the service-network gateway from constantly wasting resources.

### <Process (Flow Chart)>

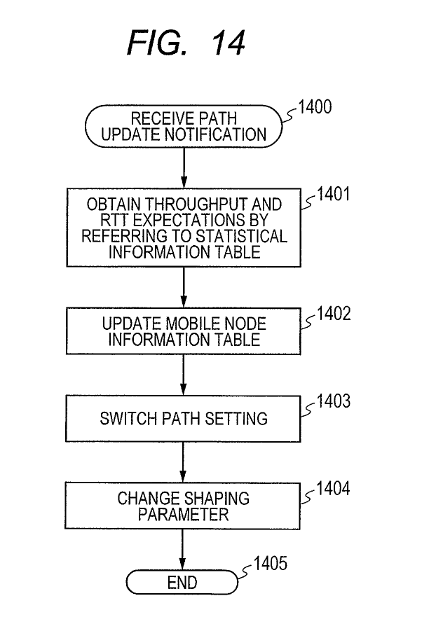

The process operation performed by the service-network gateway of the packet communication system according to the present embodiment includes three operations. More specifically, an operation in which the service-network gateway receives and processes the path update notification message, an operation in which the service-network gateway receives and processes the TCP communication packet, and an operation in which the service-network gateway rewrites the receive window size parameter (rwnd) of the ACK packet in the TCP communication. Hereinafter, the process flow of the operations of the service-network gateway will be described with reference to FIGS. 14 to 16.

FIG. 14 is an operation flow in which the service-network gateway 105 receives and processes a path update notification message. First, the service-network gateway 105 receives a path update notification message transmitted from the access gateway of one of the wireless network systems (Step 1400). This occurs when the mobile node switches the network connection to a different wireless network system. Next, the service-network gateway 105 obtains the throughput expectation and the RTT expectation in the wireless network system to which the mobile node connects, by referring to the statistical information table 311 from the information of the path update notification message (Step 1401). Then, the service-network gateway 105 updates the entry of the mobile node information table 312 for the target mobile node, based on the information of the path update message, and on the throughput expectation and the RTT expectation that are obtained in Step 1401 (Step 1402). Then, the service-network gateway 105 switches the transfer path of the communication packet addressed to the target mobile node, to the access gateway from which the path update communication message is transmitted (Step 1403). Finally, the service-network gateway 105 changes the transmission rate parameter of the shaping function included in the service-network gateway 105, to the throughput expectation obtained in Step 1401 (Step 1404), and ends the process operation (Step 1405).

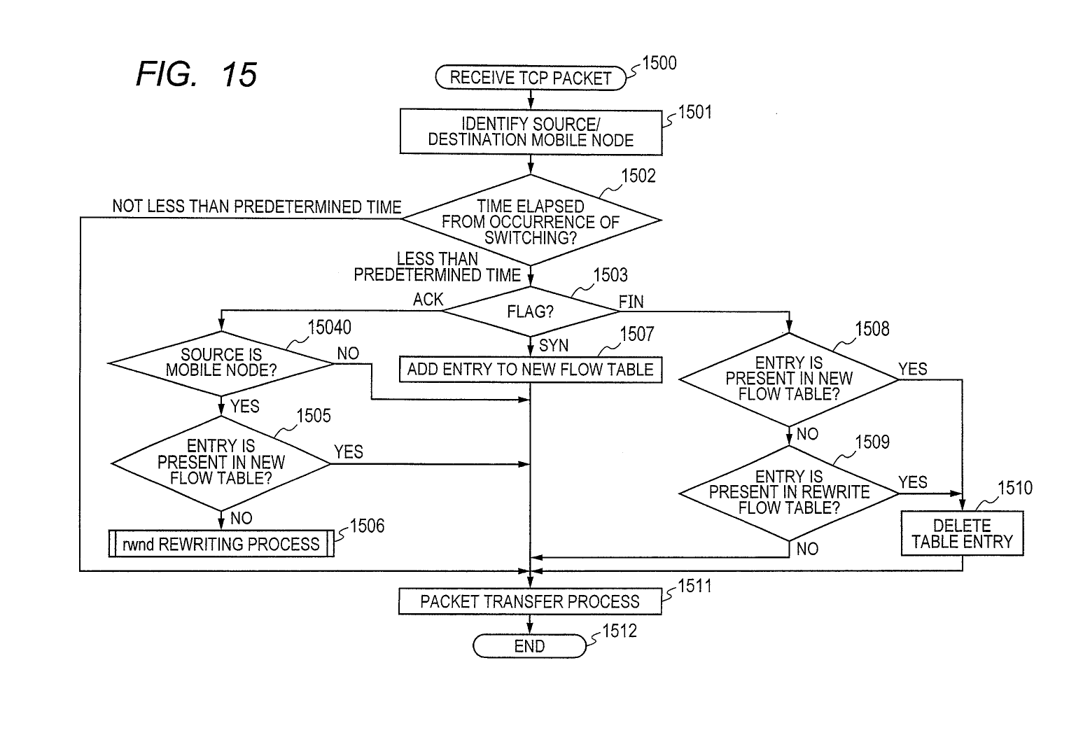

FIG. 15 is an operation flow in which the service-network gateway 105 receives and processes a TCP communication packet. First, the service-network gateway 105 receives a communication packet in the TCP communication (Step 1500). The service-network gateway 105 identifies the mobile node involved in the TCP communication from the source IP address of the communication packet, or by referring to the mobile node information table 312 from the network connection IP address (Step 1501). Then, the service-network gateway 105 refers to the elapsed time 814 of the mobile node information table 312 (Step 1502). If a predetermined time has elapsed, the service-network gateway 105 transfers the communication packet to the appropriate network or the appropriate device, as the normal process of the service-network gateway 105 (Step 1511), and ends the process operation (Step 1512).

Returning to Step 1502, if the elapsed time is not more than the predetermined time, the service-network gateway 105 examines the flag parameter in the TCP header of the communication packet (Step 1503). If the ACK flag is set, namely, if it is the ACK packet, the service-network gateway 105 checks if the source is the mobile node (Step 1504). If the source is not the mobile node, the service-network gateway 105 transfers the communication packet to the appropriate network or the appropriate device, as the normal process of the service-network gateway (Step 1511), and ends the process operation (Step 1512).

Returning to Step 1504, if the source is the mobile node, the service-network gateway 105 checks if the entry of the target TCP communication flow is present in the new flow table 313 (Step 1505). If the entry is present in the new flow table, the ACK packet of the target TCP communication is not subject to the process for rewriting the receive window size parameter. Thus, the service-network gateway 105 transfers the communication packet to the appropriate network or the appropriate device, as the normal process of the service-network gateway (Step 1511), and ends the process operation (Step 1512).

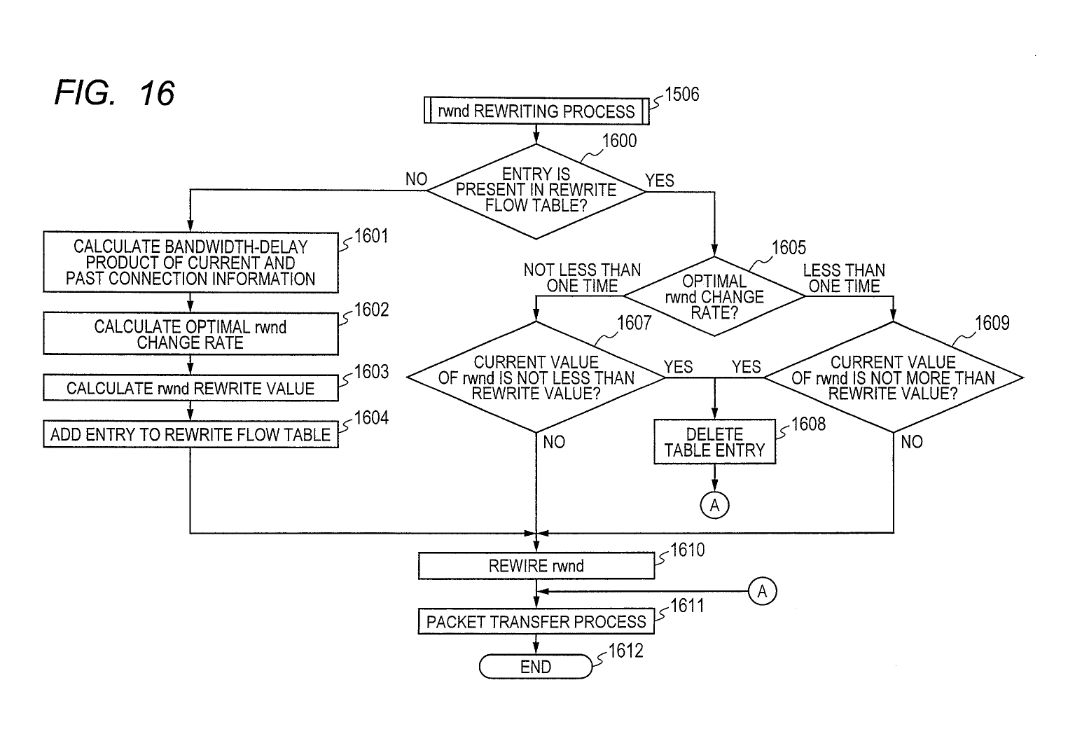

Returning to Step 1505, if there is no entry in the new flow table, the ACK packet of the target TCP communication is subject to the process for rewriting the receive window size parameter. Thus, the service-network gateway 105 proceeds to the receive window size (rwnd) rewriting process (Step 1506). The details of the process operation will be described below with reference to FIG. 16.

Returning to Step 1503, if the SYN flag is set, namely, if it is the SYN packet, the service-network gateway 105 adds an entry of the target TCP communication flow to the new flow table 313 (Step 1507). Then, the service-network gateway 105 transfers the communication packet to the appropriate network or the appropriate device, as the normal process of the service-network gateway (Step 1511), and ends the process operation (Step 1512).

Returning to Step 1503, if the FIN flag is set, namely, if it is the FIN packet, the service-network gateway 105 checks if the entry of the target TCP communication flow is present in the new flow table 313 (Step 1508). If the entry is present in the new flow table 313, the service-network gateway 105 deletes the particular entry from the table (Step 1510). Then, the service-network gateway 105 transfers the communication packet to the appropriate network or the appropriate device, as the normal process of the service-network gateway (Step 1511), and ends the process operation (Step 1512).

Returning to Step 1508, if there is no entry in the new flow table 313, the service-network gateway 105 also checks if the entry of the target TCP communication flow is present in the rewrite flow table 314 (Step 1509). If the entry is present in the rewrite flow table 314, the service-network gateway 105 deletes the particular entry from the table (Step 1510). Then, the service-network gateway 105 transfers the communication packet to the appropriate network or the appropriate device, as the normal process of the service-network gateway (Step 1511), and ends the process operation (Step 1512).

Returning to Step 1509, if there is no entry in the rewrite flow table 314, the service-network gateway 105 transfers the communication packet to the appropriate network or the appropriate device, as the normal process of the service-network gateway, without performing a specific process (Step 1511), and ends the process operation (Step 1512).

FIG. 16 is a flow chart of an operation for rewriting the receive window size parameter (rwnd) of the ACK packet in the TCP communication. This operation is triggered by Step 1506 of FIG. 15. First, the service-network gateway 105 checks if the entry of the target TCP communication flow is present in the rewrite flow table 314 (Step 1600). If there is no entry in the rewrite flow table 314, the service-network gateway 105 refers to the entry of the mobile node information table 312 for the target mobile node. Then, the service-network gateway 105 calculates the bandwidth-delay products before and after the switching of the network connection of the wireless network system, by referring to the current throughput expectation 815, the current RTT expectation 816, the past throughput expectation 821, and the past RTT expectation 822 (Step 1601). The optimal receive window sizes in the current and past wireless network system connections are the bandwidth-delay products calculated as described above, respectively. Thus, the service-network gateway 105 calculates the change rate of the optimal receive window size (rwnd) by using the bandwidth-delay products (Step 1602). The service-network gateway 105 calculates the rewrite value of the receive window size (rwnd) by multiplying the value of the receive window size described in the ACK packet, by the optimal rwnd change rate (Step 1603). The service-network gateway 105 adds an entry of the target TCP communication flow to the rewrite flow table 314, and stores the calculated optimal rwnd change rate and the calculated rwnd rewrite value (Step 1604). Then, the service-network gateway 105 rewrites the receive window size parameter of the ACK packet by the rwnd rewrite value (Step 1610). Then, the service-network gateway 105 transfers the communication packet to the appropriate network or the appropriate device, as the normal process of the service-network gateway 105 (Step 1611), and ends the process operation (Step 1512).

Returning to Step 1600, if the entry is present in the rewrite flow table 314, the service-network gateway 105 checks the optimal rwnd change rate 1105 (Step 1605). If the change rate is one or more times, the service-network gateway 105 checks if the value of the receive window size parameter of the ACK packet is not less than the rwnd rewrite value 1106 (Step 1607). If the value is smaller than the rwnd rewrite value, the service-network gateway 105 rewrites the receive window size parameter of the ACK packet by the rwnd rewrite value (Step 1610). Then, the service-network gateway 105 transfers the communication packet to the appropriate network or the appropriate device, as the normal process of the service-network gateway (Step 1611), and ends the process operation (Step 1612).

Returning to Step 1607, if the value is not less than the rwnd rewrite value, the service-network gateway 105 deletes the particular entry from the rewrite flow table 314 (Step 1608). Then, the service-network gateway 105 transfers the communication packet to the appropriate network or the appropriate device, as the normal process of the service-network gateway (Step 1611), and ends the process operation (Step 1612).

Returning to Step 1605, if the change rate is less than one time, the service-network gateway 105 checks if the value of the receive window size parameter of the ACK packet is not more than the rwnd rewrite value 1106 (Step 1609). If the value is greater than the rwnd rewrite value, the service-network gateway 105 rewrites the receive window size parameter of the ACK packet by the rwnd rewrite value (Step 1610). Then, the service-network gateway 105 transfers the communication packet to the appropriate network or the appropriate device, as the normal process of the service-network gateway 105 (Step 1611), and ends the process operation (Step 1612).

Returning to Step 1609, if the value is less than the rwnd rewrite value, the service-network gateway 105 deletes the particular entry from the rewrite flow table (Step 1608). Then, the service-network gateway 105 transfers the communication packet to the appropriate network or the appropriate device, as the normal process of the service-network gateway (Step 1611), and end the process operation (Step 1612).

By the procedure described above, in the packet communication system according to the present embodiment, it is possible to prevent the degradation of the performance due to error control for the existing TCP communication with respect to the mobile node, when the mobile node switches the network connection to a different wireless network system, without converting the mobile node and the correspondent node. As a result, the TCP communication can be stabilized with high efficiency. In addition, the service-network gateway rewrites the receive window size parameter of the ACK packet in the TCP communication from the mobile node not constantly but temporarily, so that it is possible to prevent the service-network gateway from constantly wasting resources.

It is to be understood that the present invention is not limited to the embodiment as described above and may include numerous variations. For example, the above embodiment has been described in detail for better understanding of the present invention, and the present invention is not limited to the one that includes all the configurations described above. In the above description, the configurations, functions, and processing units of the system are partially or wholly realized by the software process by the CPU executing programs. However, it goes without saying that some or all of the configurations, functions, and processing units of the system described above may be realized by the hardware, for example, by designing it with an integrated circuit.

What is claimed is:

1. A gateway device comprising a processing unit,
wherein the processing unit mediates the exchange of communication packets between a mobile node capable of wireless communication by connecting to a first wireless network system or a second wireless network system and a correspondent node capable of communication through the IP service network,
wherein when the mobile node, which is communicating with the correspondent node by connecting to the first wireless network system, switches the connection to the second wireless network system, the processing unit rewrites a received parameter in an ACK packet of the communication transmitted from the mobile node after switching from the first wireless network system to the second wireless network system, and
wherein the processing unit transfers the rewritten parameter to the correspondent node, in order to control the amount of communication packets to be transmitted from the correspondent node.

2. The gateway device according to claim 1, further comprising a storage unit for storing statistical information on the first wireless network system and the second wireless network system,
wherein the processing unit calculates the optimal receive window size for the second wireless network system from the statistical information, and
wherein the processing unit rewrites the received parameter in the ACK packet to the value of the calculated receive window size.

3. The gateway device according to claim 2,
wherein the statistical information is information on a bandwidth and delay time,
wherein the processing unit calculates the change rate between a bandwidth-delay product of the first wireless network system and a bandwidth-delay product of the second wireless network system, and
wherein the processing unit calculates the optimal receive window size for the second wireless network system by multiplying the received parameter in the ACK packet by the calculated change rate.

4. The gateway device according to claim 3,
wherein the processing unit refers to the bandwidth and delay time of the stored statistical information, by using positional information of the mobile node or current time, or both of them.

5. The gateway device according to claim 2,
wherein, when detecting a predetermined condition after rewriting the information of the ACK packet, the processing unit ends the rewriting of the received parameter in the ACK packet transmitted from the mobile node.

6. The gateway device according to claim 5,
wherein the predetermined condition is the case where the received parameter in the ACK packet transmitted from the mobile node is similar to the value of the calculated receive window size.

7. The gateway device according to claim 5,
wherein the predetermined condition is the case where an end notification packet of the communication is transmitted from the mobile node to the correspondent node, or from the correspondent node to the mobile node.

8. The gateway device according to claim 5,
wherein the predetermined condition is the case where a predetermined time has passed since the mobile node has switched the connection to the second wireless network system.

9. The gateway device according to claim 1,
wherein the processing unit can adjust the transmission interval of continuous communication packets addressed to the mobile node, and
wherein when the mobile node switches the connection to the second wireless network system, the processing unit determines the transmission interval of the continuous communication packets based on the statistical information on the bandwidths of the first and second wireless network systems.

10. The gateway device according to claim 1,
wherein the communication is the transport control protocol (TCP).

11. A packet communication method of a gateway device,
wherein the packet communication method mediates the exchange of communication packets between a mobile node capable of wireless communication by connecting a first wireless network system or a second wireless network system and a correspondent node capable of communicating through the IP service network,
wherein when the mobile node, which is communicating with the correspondent node by connecting to the first wireless network system, switches the connection to the second wireless network system, the packet communication method rewrites a received parameter in an ACK packet of the communication transmitted from the mobile node after switching from the first wireless network system to the second wireless network system, and
wherein the packet communication method transfers the rewritten parameter to the correspondent node, in order to control the amount of communication packets to be transmitted from the correspondent node.

12. The packet communication method according to claim 11,
wherein the packet communication method calculates the optimal receive window size for the second wireless network system from statistical information on the first and second wireless network systems, and
wherein the packet communication method rewrites the received parameter in the ACK packet to the value of the calculated receive window size.

13. The packet communication method according to claim 12,
wherein the statistical information is information on a bandwidth and delay time,
wherein the packet communication method calculates the change rate between a bandwidth-delay product of the first wireless network system and a bandwidth-delay product of the second wireless network system, and
wherein the packet communication method calculates the optimal receive window size for the second wireless network system by multiplying the value of the received parameter in the ACK packet by the calculated change rate.

14. The packet communication method according to claim 13,
wherein the packet communication method refers to the bandwidth and delay time of the statistical information, based on positional information of the mobile node or current time, or both of them.

15. The packet communication method according to claim 11,
wherein the gateway device can adjust the transmission interval of continuous communication packets addressed to the mobile node, and
wherein when the mobile node switches the connection to the second wireless network system, the packet communication method determines the transmission interval of the continuous communication packets based on the statistical information on the bandwidths of the first and second wireless network systems.
